(19) United States
(12) Patent Application Publication
(10) Pub. No.: US 2021/0224236 A1
(43) Pub. Date: Jul. 22, 2021

(54) PRIMARY STORAGE WITH DEDUPLICATION

(71) Applicant: Nebulon, Inc., Fremont, CA (US)

(72) Inventors: Jin Wang, Cupertino, CA (US); Siamak Nazari, Mountain View, CA (US)

(21) Appl. No.: 16/783,035

(22) Filed: Feb. 5, 2020

Related U.S. Application Data
(63) Continuation-in-part of application No. 16/748,454, filed on Jan. 21, 2020.

(51) Int. Cl. G06F 16/215; G06F 16/22

(52) U.S. Cl. CPC G06F 16/215; G06F 16/2272

(57) ABSTRACT

Storage systems and methods provide efficient deduplication with support for fine grained deduplication or deduplication with variable sized blocks. The storage system does not overwrite data in backend media but tracks operations such as writes using generation numbers, for example, to distinguish writes to the same virtual storage locations. A deduplication index, a data index, and a reference index may be used when performing operations such as reads, writes with deduplication, relocation of data blocks within backend media, and garbage collection.

### CROSS-REFERENCE TO RELATED APPLICATIONS

This patent document is a continuation-in-part and claims benefit of the earlier filing date of U.S. patent application Ser. No. 16/748,454, entitled “Efficient IO Processing in a Storage System with Instant Snapshot, Xcopy, and Unmap Capabilities,” filed Jan. 21, 2020, which is hereby incorporated by reference in its entirety.

### BACKGROUND

Primary storage systems generally require efficient use of storage space, and current storage systems often use techniques such as deduplication and compression to reduce the amount of storage space that is required in the backend media to store data. Deduplication generally involves detecting duplicated data patterns, and using one stored copy of the data pattern and multiple pointers or references to the data pattern instead of multiple stored copies of duplicated data. Typically, conventional storage systems provide faster write operations by writing all data to backend storage media as the data is received, and such systems may perform deduplication as a background process that detects and removes duplicated blocks of data in backend media. Some other storage systems use inline deduplication where duplicate data is detected before the data is stored in the backend media, and instead of writing the duplicate data to backend media, the write operation causes creation of a pointer or reference to the copy of the data that already exist in the backend media. In-line deduplication can be problematic because the processing required to detect duplicates of stored data may be complex and may unacceptably slow write operations. Efficient deduplication systems and processes are desired regardless of whether background or in-line deduplication processes are performed.

### BRIEF DESCRIPTION OF THE DRAWINGS

FIG. 1 is a block diagram illustrating a network storage system in some examples of the present disclosure.

FIG. 2 is a flow diagram illustrating a process for handling a write request in storage systems according to some examples of the present disclosure.

FIGS. 3-1, 3-2, 3-3, and 3-4 illustrate changes in virtual volumes, databases, and backend media of a storage system in some examples of the present disclosure responding to a series of write requests.

FIG. 4 illustrates changes in a virtual volume, databases, and backend media of a storage system according to some examples of the present disclosure after responding to a series of writes including writes of different data having the same deduplication signature.

FIG. 5 is a flow diagram illustrating a process for handling a read request to a virtual volume provided by a storage system according to some examples of the present disclosure.

FIG. 6 is a flow diagram illustrating a process by which storage systems in some examples of the present disclosure may move live data in backend media to another location in the backend media.

FIG. 7 illustrates changes in virtual volumes, databases, and backend media of the system of FIG. 3-3 after live data is moved from one location to another in the backend media.

FIG. 8-1 is a flow diagram of a garbage collection process in which a storage system according to some examples of the present disclosure updates a data index database.

FIG. 8-2 is a flow diagram of a garbage collection process in which a storage system according to some examples of the present disclosure updates a reference index database.

FIG. 8-3 is a flow diagram of a garbage collection process in which a storage system according to some examples of the present disclosure updates a deduplication index database.

FIG. 9-1 illustrates a virtual volume, databases, and backend media of a storage system in some examples of the present disclosure after a series of write operations.

FIG. 9-2 illustrates the virtual volume, databases, and backend media of the storage system of FIG. 9-1 after a garbage collection process in accordance with some examples of the present disclosure.

Use of the same reference symbols in different figures indicates similar or identical items.

### DETAILED DESCRIPTION

Some examples of the present disclosure can efficiently implement deduplication in storage systems that do not overwrite existing data but only write data to unused locations in the backend media. Such systems may employ generation numbers (sometimes referred to herein as gennumbers) to distinguish different versions of data that may have been written to the same virtual location, e.g., the same address or offset in a virtual volume. The storage systems may further employ an input/output processor, a deduplication module, and a garbage collector module with an efficient set of databases that enables input and output operations, detection of duplicate data, and freeing of backend storage that no longer stores needed data.

One database or index, sometime referred to herein as the data index, may be used to translate an identifier of a virtual storage location to a physical storage location of the data in backend media and to a deduplication signature of the data. The ability to look up the physical location of data corresponding to an identifier of a virtual storage location may be used in a read operation to determine what location in the storage system should be accessed in response to a read operation for the identified virtual storage location. Translation of a virtual storage location to a signature for the data associated with the virtual storage location may be used in deduplication or garbage collection processes such as described further below.

Another database or index, sometimes referred to herein as the deduplication index or ddindex, translates a combination of a signature for data and a unique ID for a data pattern to a physical location where the data pattern is available in the storage system. The ddindex may particularly be used to detect and resolve data duplicates. For example, given a signature for data, locations storing data corresponding to the signature can be found.

A reference index, sometimes referred to herein as a refindex, maps the signature of data, an identifier of a virtual storage location, and a gennumber of a write to a virtual storage location and a gennumber of a write, i.e., the same or a different write operation, that actually resulted in the data being stored in backend media. Given a signature, the reference index can return all entries indicating virtual storage locations, e.g., virtual pages identified by virtual volume IDs, offsets, and gennumbers, that correspond to specific data having the signature and can distinguish data having the same signature but different data patterns. The reference index may be particularly useful for detecting garbage, as well as when doing data relocation.

Storage systems according to some examples of the present disclosure may do fingerprinting and duplicate detection based on the I/O patterns of storage clients or on data blocks of differing sizes. A storage client, in general, may write data with a granularity that differs from the granularity that the storage system uses in backend media or from the granularity that other storage clients use. For example, a storage system that uses 8K pages in backend media might have a storage client that does random writes in 4K chunks or to 4K virtual pages, and deduplication may be most efficient if performed for 4K chunks, rather than 8K pages. Some implementation of the storage systems disclosed herein may detect duplicate data and deduplicate writes based on the size or sizes of data chunks that the storage clients employ. Further, some storage systems may perform deduplication on chunks that are the size of a virtual page and on chunks that are smaller than a virtual page.

In some examples of the present disclosure, a storage system provides high performance by never overwriting existing data in the underlying storage, i.e., backend media. Instead when writing to the backend media, the storage system writes data only to unused, i.e., empty or available, physical locations. In other words, the storage system never overwrites in place. When a given virtual storage location is written again, new (and not duplicated) data for the virtual storage location may be written to a new location in the underlying storage, the new location being different from the original physical location of old data for the same virtual storage location.

In some examples of the present disclosure, a storage system tags each incoming write with a generation number for the write. The storage system changes, e.g., increments, a global generation number for each write so different versions of data written to the same virtual location at different times may be differentiated by the different generation numbers of the two writes. Using a garbage collection process, the storage system may delete unneeded versions of data, which may be identified as being associated with generation numbers that fall outside of a desired range.

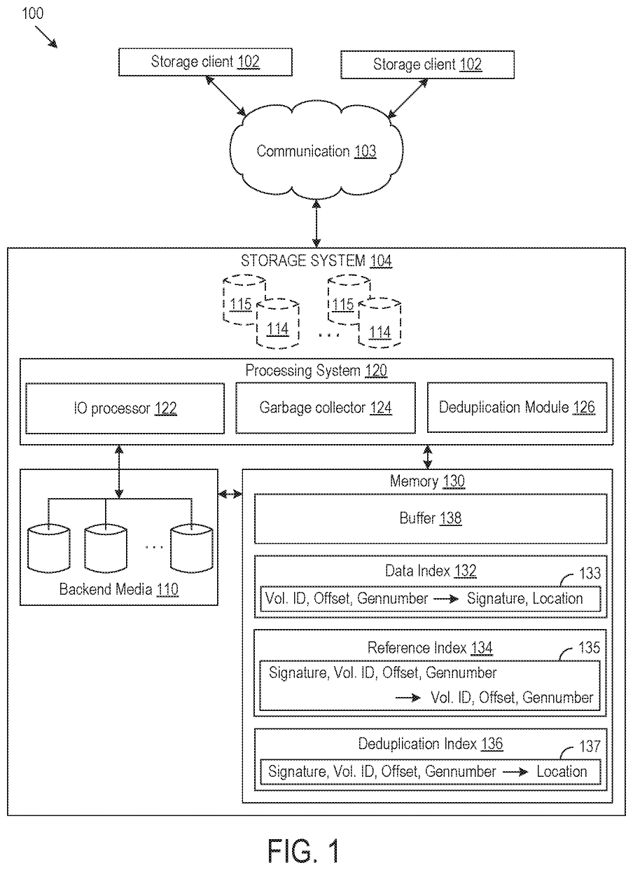

FIG. 1 is a block diagram illustrating a storage network 100 in some examples of the present disclosure. Network 100 includes computer systems such as one or more storage clients 102 and a (primary) storage system 104. Storage clients 102 and storage system 104 may be interconnected through any suitable communication system 103 having hardware and associated communication protocols, e.g., through a public network such as the Internet, a private network such a local area network, or a non-network connection such as a SCSI connection to name a few. Storage system 104 generally includes underlying storage or backend media 110. Backend storage media 110 of storage system 104 may include hard disk drives, solid state drives, or other nonvolatile storage devices or media in which data may be physically stored, and particularly may have a redundant array of independent disks (RAID) 5 or 6 configuration for performance and redundancy. Processing system 120 provides an interface to storage clients 102 that exposes base virtual volumes 114 to storage operations such as writing and reading of blocks of data. Each base virtual volume 114 may logically include a set of pages that may be distinguished from each other by addresses or offsets within the virtual volume. A page size used in virtual volumes 114 may be the same as or different from a page size used in backend media 110.

Storage system 104 may employ further virtual structures referred to as snapshots 115 that reflect the state that a base virtual volume 114 had at a time corresponding to the snapshot 115. In some examples of the present disclosure, storage system 104 avoids the need to read old data and save the old data elsewhere in backend media 110 for a snapshot 115 of a base virtual volume 114 because storage system 104 writes incoming data to new physical locations and the older versions of the incoming data remain available for a snapshot 115 if the snapshot 115 exists. If the same page or offset in a virtual volume 114 is written to multiple times, different versions of the page may be stored in different physical locations in backend media 110, and the versions of the virtual pages may be assigned generation numbers that distinguish the different versions of the page. Virtual volumes 114 may only need the page version with the highest generation number. A snapshot 115 of a virtual volume 114 generally needs the version of each page which has the highest generation number in a range between the generation number at the creation of the virtual volume 114 and the generation number at the creation of the snapshot 115. Versions that do not correspond to any virtual volume 114 or snapshot 115 are not needed, and garbage collector 124 may remove or free the unneeded pages during a “garbage collection” processes that may change the status of physical pages from used to unused.

Processing system 120 of storage system 104 generally includes one or more microprocessors or microcontrollers with interface hardware for communication through communications systems 103 and for accessing backend media 110 and volatile and non-volatile memory 130. In addition to the interface exposing virtual volumes 114 and possibly exposing snapshots 115 to storage clients 102, processing system 120 implements an input/output (I/O) processor 122, a garbage collector 124, and a deduplication module 126. I/O processor 122, garbage collector 124, and deduplication module 126 may be implemented, for example, as separate modules employing separate hardware in processing system 120 or may be software or firmware modules that are executed by the same microprocessor or different microprocessors in processing system 120.

I/O processor 122 is configured to perform data operations such as storing and retrieving data corresponding to virtual volumes 114 in backend media 110. I/O processor 122 uses stores or databases or indexes 132, 134, and 136 to track where pages of virtual volumes 114 or snapshots 115 may be found in backend media 110. I/O processor 122 may also maintain a global generation number for the entire storage network 100. In particular, I/O processor 122 may change, e.g., increment, the global generation number as writes may arrive for virtual volumes 114 or as other operations are performed, and each write or other operation may be assigned a generation number corresponding to the current value of the global generation number at the time that the write or other operation is performed.

Garbage collector 124 detects and releases storage in backend media 110 that was allocated to store data but that now stores data that is no longer needed. Garbage collector 124 may perform garbage collection as a periodically performed process or a background process. In some examples of the present disclosure, garbage collector 124 may look at each stored page and determine whether any generation number associated with the stored page falls in any of the required ranges of snapshots 115 and their base virtual volumes 114. If a stored page is associated with a generation number in a required range, garbage collector 124 leaves the page untouched. If not, garbage collector 124 deems the page as garbage, reclaims the page in backend media 110, and updates indexes 132, 134, and 136 in memory 130.

Deduplication module 126 detects duplicate data and in at least some examples of the present disclosure, prevents writing of duplicate data to backend media 110. In some alternative examples of the present disclosure, deduplication module 126 may perform deduplication as a periodic or a background process. Deduplication module 126 may be considered part of I/O processor 122, particularly when deduplication is performed during writes.

I/O processor 122, garbage collector 124, and deduplication module 126 share or maintain databases 132, 134, and 136 in memory 130, e.g., in a non-volatile portion of memory 130. For example, I/O processor 122 may use data index 132 during write operations to record a mapping between virtual storage locations in virtual volumes 114 and physical storage locations in backend media 110, and may use the mapping during a read operation to identify where a page of a virtual volume 112 is stored in backend media 110. Data index 132 may additionally include deduplication signatures for the pages in the virtual volumes 114, which may be used for deduplication or garbage collection as described further below. Data index 132 may be any type of database but in one example data index 132 is a key-value database including a set of entries 133 that are key-value pairs. In particular, each entry 133 in data index 132 corresponds to a key identifying a particular version of a virtual storage location in a virtual volume 114 or snapshot 115 and provides a value indicating a physical location containing the data corresponding to the virtual storage location and a deduplication signature for the data. For example, the key of a given key-value pair 133 may include a virtual volume identifier, an offset of a page in the identified virtual volume, and a generation number of a write to the page in the identified virtual volume, and the value associated with the key may indicate a physical storage location in backend media 110 and the deduplication signature for the data.

Reference index 134 and deduplication index 136 may be maintained and used with data index 132 for deduplication processes and garbage collection processes. Reference index 134 may be any type of database but in on example of the disclosure reference index 134 is also a database including entries 135 that are key-value pairs, each pair including: a key made up a signature for data, an identifier of a virtual storage location for a write of the data, and a generation number for the write; and a value made up of an identifier of a virtual storage location and a generation number for an “initial” write of the same data. In one implementation, each identifier of a virtual storage location includes a volume ID identifying the virtual volume and an offset to a page in the virtual volume. The combination of a signature of data and the volume ID, the offset, and the generation number of the initial write of the data can be used as a unique identifier for a data pattern available in storage system 104. Deduplication index 136 may be any type of database but in one example is a database including entries 137 that are key-value pairs 137. In particular, each entry 137 corresponds to a key including a unique identifier for a data pattern available in storage system 104 provides a value indicating a physical location of the data pattern in backend media 110.

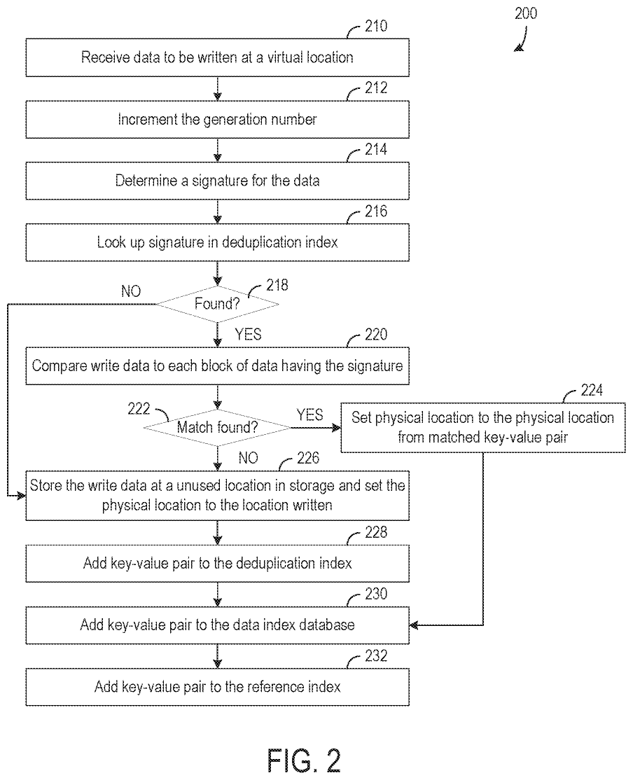

FIG. 2 is a block diagram illustrating a method 200 for handling a write from a storage client 102 in some examples of the present disclosure. (Method 200 is particularly described herein with reference to the structure of FIG. 1 to illustrate a specific example, but the process may be similarly employed in alternative storage system structures.) Method 200 may begin in block 210. In block 210, I/O processor 122 receives a write to an offset in a virtual volume 114. The write generally includes data to be written, also referred to as write data, and the write data may correspond to all or part of a single page in a virtual volume or may correspond to multiple full virtual pages with or without one or more partial virtual pages. The following description is primarily directed a write of a single page or partial page, but more generally a write of multiple pages can be performed by repeating the single page processes. In any case, the write data may initially be stored in a buffer 138 in a non-volatile portion of memory 130 in storage system 104. In some examples, receiving data of block 210 includes reporting to a storage client that the write is complete when the write data is in buffer 138, even though write data has not yet been stored to back end media 110 at that point. A non-volatile portion of memory 130 may be used to preserve the write data and the state of storage system 104 in the event of a power disruption, enabling storage system 104 to complete write operations once power is restored. Block 210 may be followed by block 212.

In block 212, I/O processor 122 increments or otherwise changes a current generation number in response to the write. The generation number is global for the entire storage network 100 as writes may arrive for multiple base volumes 114 and from multiple different storage clients 102. Block 212 may be followed by block 214.

In block 214, deduplication module 126 determines a signature of the write data, e.g., of a full or partial virtual page of the write. The signature may particularly be a hash of the data, and deduplication module 126 may evaluate a hash function of the data to determine the signature. The signature is generally much smaller than the data, e.g., for an 8 KiB data page, the signature may be between 32 bits to 256 bits. Some example hash functions that may be used in deduplication operations include cryptographic hashes like SHA256 and non-cryptographic hashes like xxHash. In some examples, the signature may be calculated for blocks of different sizes, e.g., partial pages of any size. The deduplication processes may thus be flexible to detect duplicate data of the block or page sized used by storage clients 102 and is not limited to deduplication of data corresponding to a page size in backend media 110. In contrast, conventional storage systems typically perform deduplication using a fixed predetermined granularity (typically, the page size of the backend media). For example, a conventional storage system that employs a page size of 8 KiB may split data for incoming writes into one or more 8 KiB pages and calculate a deduplication signature for each 8K page. Storage systems in some of the examples provided in the present disclosure may be unconcerned with the size of the data being written, and may calculate a signature for any amount of write data. As described further below, if the signature (and data pattern) matches the signature (and data pattern) of stored data, instead of writing the data again to backend media 110 and setting a pointer to the newly written data, a deduplication write can set a pointer to the location where the duplicate data was previously saved. Block 214 may be followed by block 216.

In block 216, deduplication module 126 looks in deduplication index 136 for a match of the calculated signature. If a decision block 218 determines that the calculated signature is not already in deduplication index 136, the data is not available in storage system 104, and process 200 branches from block 218 to block 226, where I/O processor 122 stores the write data in backend media 110 at a new location, i.e., a location that does not contain existing data. (For efficient or secure storage, storing of the write data in backend media 110 may include compression or encryption of the write data written to a location in backend media 110.) For any write to any virtual volume 114, block 226 does not overwrite any old data in backend media 110 with new data for the write. When block 226 writes to backend media 110, a block 228 adds a new key-value pair 137 to deduplication index 136. The new key-value pair 137 has a key including: the signature that block 214 calculated for the data; an identifier for the virtual storage location, i.e., a virtual volume ID and an offset, being written; and the current generation number. The new key-value pair 137 has a value indicating the location where the data was stored in backend media 110. Block 228 may be followed by a block 230.

In block 230, I/O processor 122 adds a key-value pair 133 in data index 132. In particular, I/O processor 122 adds a key-value pair 133 in which the key includes an identifier of a virtual storage location (e.g., a volume ID and an offset of a virtual page) and a generation number of the write and in which the value includes the signature of the data and the physical location of the data in backend media 110. Block 230 may be followed by a block 232.

In block 232, I/O processor 122 adds a key-value pair 135 to reference index 134. In particular, I/O processor 122 add a key-value pair in which the key includes the signature, the volume ID, the offset, and the generation number of the current write and the value includes the volume ID, the offset, and the generation number of an initial write that resulted in storing the write data in backend media 110. The value for the key-value pair 135 added to reference index 134 may be determined from deduplication index 136 in the key of the key-value pair 137 that points to the location where the data is available. Completion of block 232 may complete the write operation.

If decision block 218 determines that the signature for the current write is already in deduplication index 136, a block 220 compares the write data to each block of stored data having a matching signature. In particular, block 220 compares the write data to the data in each physical location that deduplication index 136 identifies as storing data with the same signature as the write data. In general, one or more key-value pair 137 in deduplication index 136 may have a key containing a matching signature because many different pages with different data patterns can generate the same signature. A decision block 222 determines whether block 220 found stored data with a pattern matching the write data. If not, method 200 branches from decision block 222 to block 226 and proceeds through blocks 226, 228, 230, and 232 as described above. In particular, data is written to a new location in backend media 110, and new entries 133, 135, and 137 are respectively added to data index 132, reference index 134, and deduplication index 136. If decision block 222 determines that block 220 found stored data matching the write data, the write data is duplicate data that does not need to be written to backend media 110, and a block 224 extracts from deduplication index 136 the physical location of the already available matching data. Process 200 proceeds from block 224 to block 230, which creates a key-value pair 133 in the data index data base 132 to indicate were to find the data associated with the virtual storage location and generation number of the write. Reference index 134 is also updated as described above with reference to block 232.

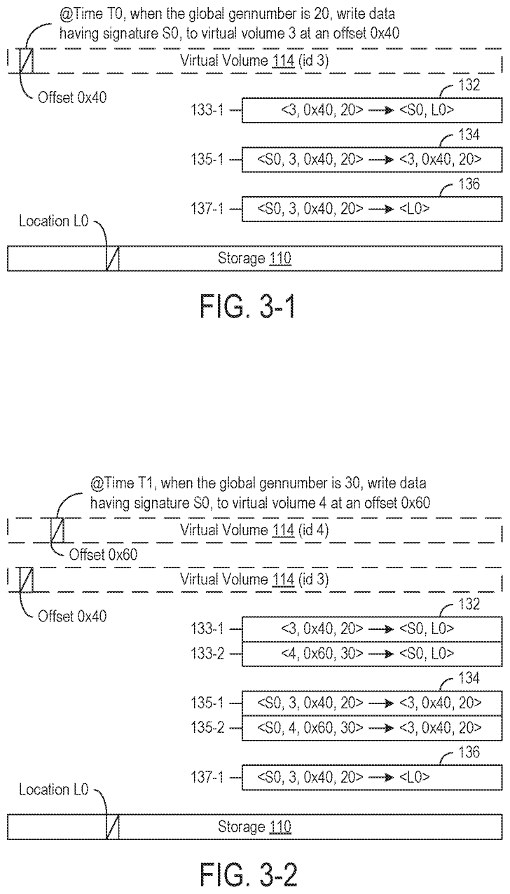

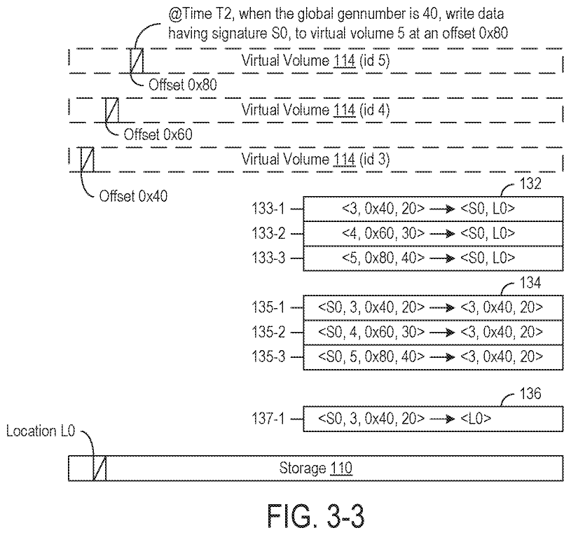

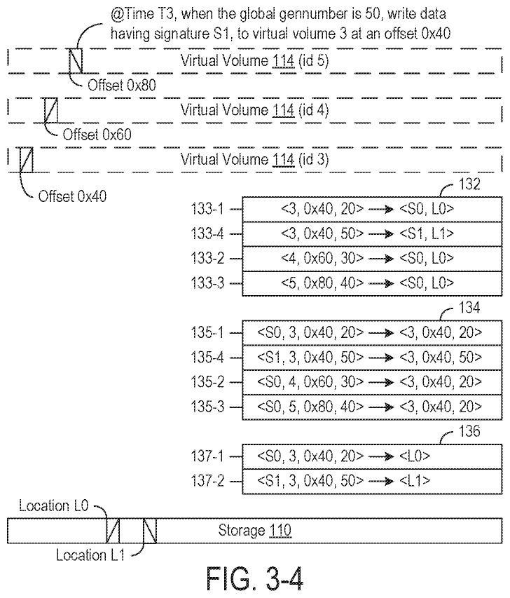

FIGS. 3-1, 3-2, 3-3, and 3-4 illustrate results of a series of write operations in a storage system such as storage system 104 of FIG. 1. FIG. 3-1 particularly shows a virtual volume 114, data index 132, reference index 134, deduplication index 136, and storage 110. Initially, storage 110, data index 132, reference index 134, and deduplication index 136 are empty. An initial write, in the illustrated example, has a generation number 20, occurs at a time T0, and directs storage system 104 to write data to a virtual page at an offset 0x40 in virtual volume 114 with a volume ID of 3. The write data has a signature S0. Since no data available in the storage system has signature S0, the write data is stored in a new location L0 in backend media 110. After the write, data index 132 includes a key-value pair 133-1 including the volume ID value 3, the offset value 0x40, and generation number 20 of the write as key. The value in key-value pair 133-1 includes the signature S0 and the location L0 of the stored data. Deduplication index 136 includes a key-value pair 137-1 including the signature S0, the volume ID 3, the offset 0x40, and the generation number 20 of the write as key. The value in key-value pair 137-1 indicates the location L0 of the stored data. Reference index 134 includes a key-value pair 135-1 having the signature S0, the volume ID 3, the offset 0x40, and the generation number 20 of the write as key. The value in key-value pair 135-1 includes the volume ID 3, the offset 0x40, and the generation number 20 from the key of deduplication entry 137-1 that indicates where the data pattern is in backend media 110.

FIG. 3-2 shows two virtual volumes 114, data index 132, reference index 134, deduplication index 136, and storage 110 after a time T1 of a write of data having the same data pattern as data of the write at time T0. The write at time T1 has a generation number 30 and directs the storage system 104 to write data to an offset 0x60 in a virtual volume 114 having a volume ID 4. The write data has a signature S0 and the same data pattern as previously written to location L0 in backend media 110. For the write having generation number 30, deduplication module 126 detects that entry 137-1 in deduplication index 136 has the same signature S0, and a comparison of the write data to the data at the location L0 given in entry 137-1 identifies the same data pattern for both. An entry 133-2 is added to data index 132 and includes the volume ID 4, the offset 0x60, and the generation number 30 of this write as its key. The value in key-value pair 133-2 includes the signature S0 and the location L0 in which the data was stored during the write having the generation number 20. The write having generation number 30 does not change deduplication index 136, but an entry 135-2 is added to reference index 134 and includes the signature S0, the volume ID 4, the offset 0x60, and the generation number 30 of the write as key. The value in key-value pair 135-2 includes the volume ID 3, the offset 0x40, and the generation number 20 from the key of deduplication entry 137-1 indicating where the data pattern is in storage 110.

FIG. 3-3 shows three virtual volumes 114, data index 132, reference index 134, deduplication index 136, and storage 110 after a time T2 of a write of data to an offset 0x80 in a virtual volume 114 having a volume ID 5. For this example, the write at time T2 has a generation number 40, and the write data again has the same signature S0 and the same data pattern as the data of the initial write operation. For the write at time T2, the deduplication module again detects entry 137-1 in deduplication index 136 as having the same signature S0 as the write data, and a comparison of the write data to the data stored at the location L0 given in entry 137-1 identifies the same data pattern for the write at time T2. An entry 133-3 is added to data index 132 and includes the volume ID 5, the offset 0x80, and the generation number 40 of this write as key. The value in key-value pair 133-3 includes the signature S0 of the write data and the location L0 in which the data pattern was stored. Deduplication index 136 remains unchanged by the write at time T2. An entry 135-3 is added to reference index 134 and includes the signature S0, the volume ID 5, the offset 0x80, and the generation number 40 of the write as key. The value in entry 135-3 includes the volume ID 3, the offset 0x40, and the generation number 20 from the key of deduplication entry 137-1 indicating where the data pattern is in storage 110.

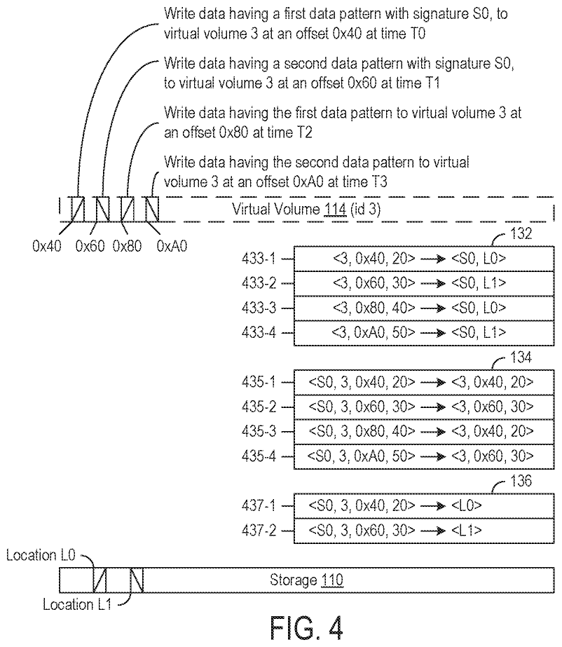

FIG. 3-4 illustrates three virtual volumes 114, data index 132, reference index 134, deduplication index 136, and storage 110 after a write operation at a time T3. The write operation at time T3 directs the storage system to overwrite the page at offset 0x40 in virtual volume 114 having volume ID of 3. In this example, the write at time T3 is assigned a generation number 50, and the write data is determined to have a signature S1. Since deduplication index 136 indicates that no data available in the system has signature S1, the data of the write at time T3 is stored in a new location L1 in storage 110. In particular, the data pattern at location L0 is not overwritten, which is important in this case because data of other needed virtual pages has the data pattern stored in location L0. After the write at time T3, data index 132 includes a key-value pair 133-4 having the volume ID 3, the offset 0x40, and the generation number 50 of the write at time T3 as key. The value in key-value pair 133-4 includes the signature S1 and the location L1 of the stored data pattern. Deduplication index 136 is updated to include a key-value pair 137-2 having the signature S1, the volume ID 3, the offset 0x40, and the generation number 50 of the write as key. The value in key-value pair 137-2 indicates the location L1 of the data pattern of the write having generation number 50. Reference index 134 includes a new key-value pair 135-4 having the signature S1, the volume ID 3, the offset 0x40, and the generation number 50 of the write at time T3 as key. The value in key-value pair 135-4 includes the volume ID 3, the offset 0x40, and the generation number 50 from the key of deduplication entry 137-2 indicating where a data pattern having signature S1 is in backend media 110.

FIG. 3-4 shows data index 132 as still including key-value pair 133-1 and reference index 134 still including key-value pair 135-1. Key-value pair 133-1 may be deleted from data index 132 if the portion of the virtual volume 114 with volume ID 3 does not have a snapshot 115 or if all still-existing snapshots 115 of the virtual volume 114 with volume ID 3 were created after generation number 50. Key-value pair 135-1 may be deleted from reference index 134 under the same circumstances. I/O processor 122 could update data index 132 and reference index 134 to delete no-longer-need key-value pairs as part of a write process, e.g., delete or overwrite key value pairs 133-1 and 135-1 when performing the write having generation number 50. Alternatively a garbage collection process may delete no-longer-needed key-value pairs.

FIG. 4 illustrates a state of storage system 104 after a set of writes that includes writing of data that creates a deduplication collision, i.e., two writes of data having the same signature S0 have different data patterns. FIG. 4 particularly shows a virtual volume 114, data index 132, reference index 134, deduplication index 136, and storage 110 after a series of write operations. At a time T0, the generation number is 20, and the write operation directs storage system 104 to write data having a first data pattern with a signature S0 to an offset 0x40 in virtual volume 114 with a volume ID of 3. The write at time T0 is the first write of the first data pattern and results in data with the first data pattern being stored in a new location L0 in backend media 110. An entry 433-1 in data index 132 is set to <3, 0x40, 20>→<S0, L0>, an entry 435-1 in reference index 134 is set to <S0, 3, 0x40, 20>→<3, 0x40, 20>, and an entry 437-1 in deduplication index 136 is set to <S0, 3, 0x40, 20>→<L0>.

A write at a time T1 in FIG. 4 is assigned a generation number 30 and directs storage system 104 to write data having a second data pattern but the same signature S0 to an offset 0x60 in virtual volume 114 with a volume ID of 3. During the write with generation number 30, deduplication module 126 calculates (e.g., block 214, FIG. 2) signature S0 from the data having the second data pattern, finds (e.g., block 218, FIG. 2) signature S0 in entry 437-1 of deduplication index 136, compares (e.g., block 220, FIG. 2) the write data having the second data pattern to the data that deduplication index 136 identifies as being stored in location L0, and determines (e.g., block 222 of FIG. 2) that the first and second data patterns do not match. The write at time T1 results in data with the second data pattern being stored in a new location L1 in backend media 110. An entry 433-2 in data index 132 is set to <3, 0x60, 30>→<S0, L1>, entry 435-2 in reference index 134 being set to <S0, 3, 0x60, 30>→<3, 0x60, 30>, and an entry 437-2 in deduplication index 136 is set to <S0, 3, 0x60, 30>→<L1>. At this point, deduplication index 136 contains two entries with keys including the same signature S0, but the keys are unique because the keys also include respective identifiers, i.e., <3, 0x40, 20> and <3, 0x60, 30>, that are unique at least because the generations numbers when different data patterns are first written must be different.

A write at a time T2 in FIG. 4 is assigned generation number 40 and directs storage system 104 to write data having the first data pattern to an offset 0x80 in the virtual volume 114 with volume ID of 3. The write with generation number 40 does not require writing to backend media 110 since deduplication module 126 finds entry 437-1 deduplication index 136 points to location <L0> that already contains the first data pattern. In particular, entries 437-1 and 437-2 having signature S0 are found (e.g., block 218 of FIG. 2) in deduplication index 136, and comparisons (e.g., block 220 of FIG. 2) finds location <L0> stores the first data pattern. The write with generation number 40 results in entry 433-3 in data index 132 being set to <3, 0x80, 40>→<S0, L0>, entry 435-3 in reference index 134 being set to <S0, 3, 0x80, 40>→<3, 0x40, 20>. Deduplication index 136 is not changed for the write at time T2.

A write at a time T3 in FIG. 4 is assigned generation number 50 and directs storage system 104 to write data having the second data pattern to an offset 0xA0 in the virtual volume 114 with volume ID of 3. The write with generation number 50 also does not require writing to backend media 110 since deduplication module 126 checks the entries in deduplication index 136 and finds that entry 437-2 in deduplication index 136 points to location <L1> that already contains the second data pattern. The write with generation number 50 results in an entry 433-4 in data index 132 being set to <3, 0xA0, 50>→<S0, L1> and an entry 435-4 in reference index 134 being set to <S0, 3, 0xA0, 50>→<3, 0x60, 30>. Deduplication index 136 is not changed for the write at time T3.

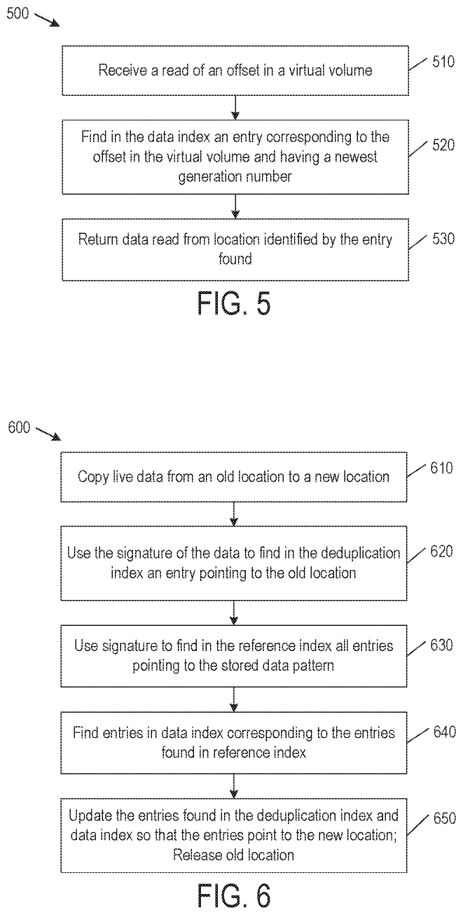

FIG. 5 is a block diagram illustrating a process 500 for I/O processor 122 to handle a read request to a virtual volume 114 in some examples of the present disclosure. Method 500 may begin in block 510, where storage system 104 receives from a storage client 102 a read request indicating a virtual storage location, e.g., an offset in a virtual volume, to be read. Block 510 may be followed by block 520.

In block 520, I/O processor 122 searches data index 132 for all entries corresponding to the offset and virtual volume 114 of the read. Specifically, I/O processor 122 queries data index 132 for all the key-value pairs with keys containing the offset and the virtual volume identified in the read request. Block 520 further finds which of the entries 133 found has the newest (e.g., the largest) generation number. Block 520 may be followed by block 530.

In block 530, I/O processor 122 reads data from the location in backend media 110 identified by the entry 133 that block 520 found in data index 132 and returns the data to the storage client 102 that sent the read request. In general, reading from backend media 110 may include decompression and/or decryption of data that was compressed and/or encrypted during writing to backend media 110. Block 530 may complete read process 500.

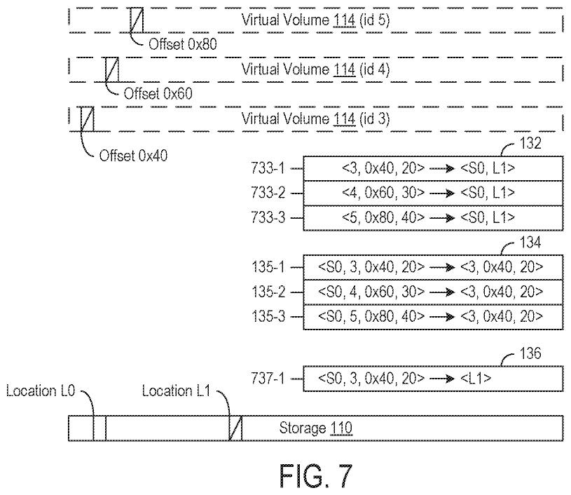

FIG. 6 is a block diagram of a process 600 for moving live data from one location to another in backend media. A storage system such as storage system 104 may employ process 600, for example, in a defragmentation process to more efficiently arrange stored data in backend media 110. FIG. 3-3 shows an example of a storage system storing a data pattern with signature S0 in a location L0 of backend media 110, and FIG. 7 shows results of a move operation that moves the data pattern from location L0 in backend media 110 to a new location L1 in backend media 110. When the location on backend media where the data is saved changes, all entries, e.g., key-value pairs, that point to the backend location need to be changed. Process 600 may use the deduplication index, the reference index, and the data index in an effective reverse lookup to identify entries that need to be changed for a move operation.

Process 600 may begin in block 610, where storage system 104 writes data from one location in backend media 110 to a new location in backend media 110. The new location is a portion of backend media 110 that immediately before block 610 did not store needed data. Block 610 of FIG. 6 may be followed by block 620.

In block 620, storage system 104 may use the signature of the data moved to find an entry in the deduplication index corresponding to the original location of the data moved. A signature of the data being moved may be calculated from the (possibly decompressed or decrypted version of the) data being moved. A query to the deduplication index 136 may request all entries having the calculated signature, and the entries in the deduplication index 136 corresponding to the moved block may be identified based on the location values of the entries. For example, a query to deduplication index 136 in FIG. 3-3 requesting entries with signature S0 of the block at location L0 returns a single entry 137-1 and the value of entry 137-1 is location L0, indicating that entry 137-1 corresponds to the moved block and needs to be update by the time the move operation is complete. Block 620 of FIG. 6 may be followed by block 630.

In block 630, storage system 104 may use the signature of the data moved to find entries 135 in the reference index 134 corresponding to the data pattern moved. A query to the reference index 134 may request all entries having the previously determined signature, and the returned entries from the reference index 134 may be checked to determine whether the values of the returned entries from the reference index 135 match the virtual volume ID, offset, and generation number that are part of the key of the deduplication index entry that block 620 found. The reference entries 135 that do (or do not) match correspond (or do not correspond) to the moved data pattern. For example, a query to reference index 134 in FIG. 3-3 requesting entries with signature S0 returns entries 135-1, 135-2, and 135-3, and comparison of the values from entries 135-1, 135-2, and 135-3 with the key of the identified entry 137-1 of deduplication index 136 indicates that all of the entries 135-1, 135-2, and 135-3 correspond to the moved block. Block 630 of FIG. 6 may be followed by block 640.

In block 640, the keys from the entries from the reference index found to correspond to the moved data pattern are used to identify entries in the data index that correspond to the moved data pattern. For example, queries to data index 132 in FIG. 3-3 requesting entries with virtual locations from entry 135-1, 135-2, and 135-3 respectively return entries 133-1, 133-2, and 133-3 from data index 132, indicating that entries 133-1, 133-2, and 133-3 from data index 132 need to be updated by the time the move operation is complete. Block 640 of FIG. 6 may be followed by block 650.

In block 650, the entries identified in the deduplication index and the data index are updated to use the new location of the moved data pattern. FIG. 7, for example, shows three virtual volumes 114, data index 132, reference index 134, deduplication index 136, and backend media 110 when a move operation is performed on a system starting with the state shown in FIG. 3-3. In particular, entry 137-1 of deduplication index 136 of FIG. 3-3 is updated from <S0, 3, 0x40, 20>→<L0> to entry 737-1 of deduplication index 136 of FIG. 7 having key-value <S0, 3, 0x40, 20>→<L1>. Entries 133-1, 133-2, and 133-3 of data index 132 of FIG. 3-3 are respectively updated from <3, 0x40, 20>→<L0>, <4, 0x60, 30>→<L0>, and <5, 0x80, 40>→<L0> to entries 733-1, 733-2, and 733-2 of data index 132 of FIG. 7 having key-values <3, 0x40, 20>→<L1>, <4, 0x60, 30>→<L1>, and <5, 0x80, 40>→<L1>. More generally, updating entries of the deduplication index and the data index for a move operation may be performed when the entries are found, e.g., in block 620 and 640. Block 650 may complete the move operation by releasing the old location, i.e., may make the old location available for storage of new data.

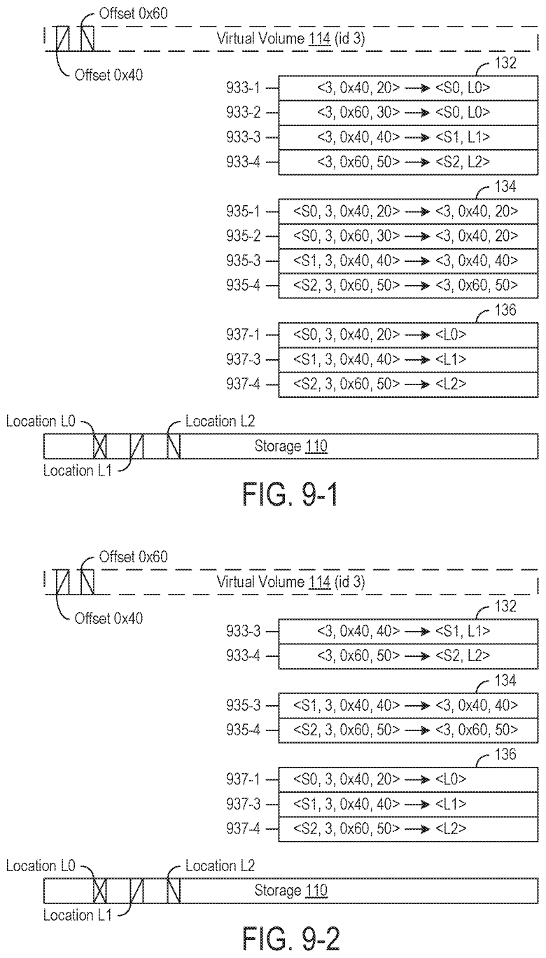

FIGS. 8-1, 8-2, and 8-3 are flow diagrams illustrating examples of garbage collection processes according to some examples of the present disclosure. The garbage collection procedures may be used to free storage space in backend media and delete unneeded entries from the data index, the reference index, and the deduplication index in storage systems according to some examples of the present disclosure. FIG. 9-1, for example, shows the state of a virtual volume 114 with volume ID 3, databases 132, 134, and 136, and backend media 110 of storage system 104 after a series of write requests. In particular, a write request with generation number 20 and a data pattern with signature S0 to a virtual page having offset 0x40 in the virtual volume 114 with volume ID 3 causes writing of the data to a location L0 in storage 110. Execution of the write request with generation number 20 cause creation of an entry 933-1 in data index 132, an entry 935-1 in reference index 134, and an entry 937-1 in deduplication index 138. A write request with generation number 30 with the same data pattern with signature S0 writes to a virtual page having offset 0x60 in the virtual volume 114 with volume ID 3 and does not result in writing to storage 110 because the data pattern is already stored at location L0. Execution of the write request with generation number 30 cause creation of an entry 933-2 in data index 132 and an entry 935-2 in reference index 134. A write request with generation number 40 overwrites the virtual page having offset 0x40 in the virtual volume 114 with volume ID 3 with data having a signature S1 and causes writing of the data with signature S1 to a location L1 in storage 110. Execution of the write request with generation number 40 cause creation of an entry 933-3 in data index 132, an entry 935-3 in reference index 134, and an entry 937-3 in deduplication index 138. A write request with generation number 50 overwrites the virtual page having offset 0x60 in the virtual volume 114 with volume ID 3 with data having a signature S2 and causes writing of the data with signature S2 to a location L2 in storage 110. Execution of the write request with generation number 50 cause creation of an entry 933-4 in data index 132, an entry 935-4 in reference index 134, and an entry 937-4 in deduplication index 138. The series of write operations resulting in the storage system state illustrated in FIG. 9-1 overwrote all virtual locations that corresponded to data having signature S0, so that location L0 in storage 110 and some entries in the databases are unneeded if no snapshots 115 exist or all snapshots 115 corresponding to the overwritten virtual storage locations were created after generation number 50.

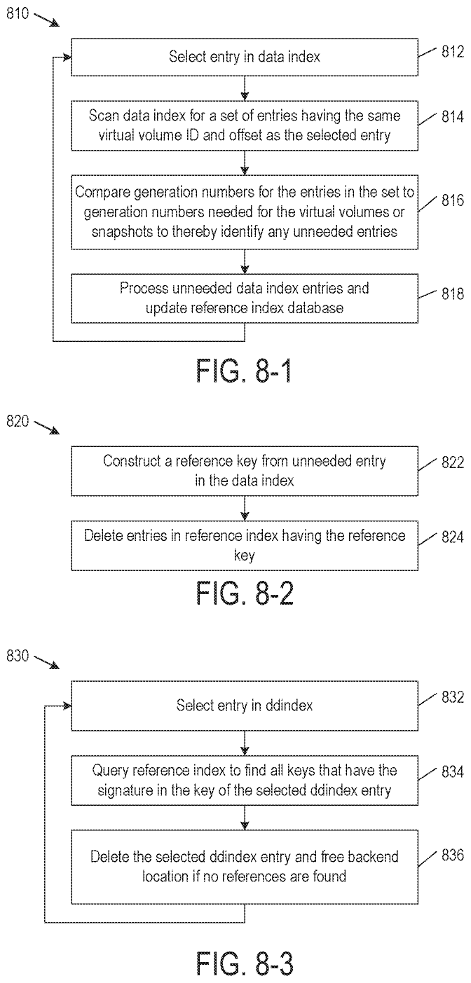

FIG. 8-1 shows an example of a process 810 for garbage collection based on a data index of a storage system. The garbage collector, e.g., garbage collector 124 of FIG. 1, may begin process 810 with a block 812 by selecting an entry in the data index database, e.g., an entry 933-1 in data index 132 of FIG. 9-1. In a block 814, the garbage collector may then scan the data index database for all entries having a key identifying the same portion of the same virtual volume, e.g., having a key containing the same virtual volume ID and the same offset, as does the key of the selected entry in the data index database. For example, entries 933-1 and 933-3 in FIG. 9-1 have keys including the same virtual volume and offset but have different generation numbers. For all keys found for the same virtual volume portion, the garbage collector in block 816 checks the generation numbers in the keys to determine which entries need to be retained. In particular, the entry, e.g., entry 933-3, with the newest, e.g., largest, generation number needs to be retained for reads of the portion of the virtual volume 114. Also, any entries having the newest generation numbers that are older than respective generation numbers corresponding to creation of snapshots 115 are needed for the snapshots 115 and need to be retained. Any entries, e.g., entry 933-1, that are not need for a virtual volume 114 or a snapshot 115 may be deleted, e.g., may be considered as garbage. The garbage collector in block 818 processes each unneeded data index entry. Block 818 may particularly include deleting the unneeded entries from the data index database and updating of the reference index database.

FIG. 8-2 is a flow diagram a process 820 for updating the reference index database, which may be performed in block 818 of FIG. 8-1 for each identified unneeded data index entry. Process 820 may begin in a block 822 with construction of a reference key from an unneeded entry in the data index database. For example, the value from the unneeded data index entry 933-1 provides a signature, e.g., S0, that may be combined with the key, e.g., <3, 0x40, 20> from the unneeded data index entry 933-1 to create a key, e.g., <S0, 3, 0x40, 20> for a query to the reference index database. The entry, e.g., entry 935-1, returned as a result of using the constructed key in the query to the reference index database is unneeded, and in a block 824, the garbage collector may delete the unneeded entry from the reference index database. Block 824 may complete process 820, but the garbage collector may repeat process 820 for each unneeded data index entry, e.g., for entry 933-2 in FIG. 9-1. FIG. 9-2 shows the storage system of FIG. 9-1 after a garbage collection process removes entries 933-1, 933-2, 935-1, and 935-2.

FIG. 8-3 is a flow diagram of a further garbage collection process 830 for updating the deduplication index database, e.g., deduplication index 136 of FIG. 9-2, and freeing storage space, e.g., location L0 in backend media 110 of FIG. 9-2. The garbage collector, e.g., garbage collector 124 of FIG. 1, can begin process 830 with a block 832 that selects an entry in the deduplication index database, e.g., entry 937-1 in deduplication index 136 of FIG. 9-2. In a block 834, the garbage collector uses the key from the selected deduplication index entry in a query of the reference index, e.g., in a query of reference index 134 of FIG. 9-2. For example, the key used for searching the reference index is the signature S0 from the selected deduplication index entry 937-1, and all the entries from the refindex that match the signature are then compared to see if their values match the unique data identifier, e.g., the volume ID, offset, and gennumber, from the ddindex key or <3, 0x40, 20> for entry 937-1. If the query or search fails to return a reference index entry corresponding to the key of the selected deduplication index entry, the deduplication entry is unneeded, which is the case for entry 937-1 in FIG. 9-2, and in a block 836, the garbage collector frees or otherwise makes available for new data storage the location to which the selected deduplication index entry points, e.g., L0 to which entry 937-1 points. The garbage collector further deletes the unneeded deduplication index entry, e.g., deletes entry 937-1 in this example.

All or portions of some of the above-described systems and methods can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A process for operating a storage system including a processing system and backend media, the process comprising:
the storage system receiving a series of requests for writes respectively to a series of virtual storage locations, and
for each of the requests, executing an operation that comprises:
assigning to the request a generation number the uniquely identifies the request;
calculating a signature from write data associated with the request; and
providing, in a data index database, a first entry that corresponds to the generation number and an identifier of the virtual storage location, the first entry providing the signature and an identifier of a physical location in which a data pattern matching the write data is stored in the backend media.

2. The process of claim 1, wherein the operation for each of the requests further comprises providing, in a reference database, a second entry that corresponds to the signature, the identifier of the virtual storage location of the request, and the generation number of the request, the second entry providing the generation number and the identifier of the virtual storage location from a request that caused writing of the write data to the physical location in which a data pattern matching the write data is stored in the backend media.

3. The process of claim 2, wherein the operation for each of the requests further comprises:
querying a deduplication database to determine whether any entry in the deduplication database corresponds to the signature of the write data for the request;
in response to determining that no entry in the deduplication database corresponds to the signature, storing the write data at the physical location in the backend media and providing, in the deduplication database, a third entry that corresponds to the signature, the identifier of the virtual storage location, and the generation number, the third entry providing the identifier of the physical location in which the write data is stored in the backend media;
in response to determining that one or more entries in the deduplication database correspond to the signature, performing a sub-process including:
determining whether the write data is a duplicate of any stored data that is in the backend media at one or more locations respectively provided by the one or more entries returned by the querying of the deduplication database;
in response to the write data not being a duplicate, storing the write data in the physical location in the backend media and providing, in the deduplication database, the third entry that corresponds to the signature, the identifier of the virtual storage location, and the generation number, the third entry providing the identifier of the physical location; and
in response to the write data being a duplicate, leaving the deduplication database unchanged.

4. The process of claim 3, wherein each of the data index database, the reference database, and the deduplication database comprises a key-value database.

5. The process of claim 1, wherein each of the first entries includes a key and a value, the key containing the generation number and the identifier of the virtual storage location of the request corresponding to the first entry, and the value containing the signature and an identifier of the physical location in which the write data of the request corresponding to the first entry is stored in the backend media.

6. A process executed by a storage system that includes a processing system and backend media, the process comprising:
assigning a generation number to a write request that includes write data and an identifier of a virtual storage location;
determining a signature for the write data;
querying a deduplication database to determine whether any entry in the deduplication database corresponds to the signature;
in response to determining that no entry in the deduplication database corresponds to the signature, performing a first sub-process including:
storing the write data at an unused location in the backend media;
providing, in the deduplication database, a first entry that corresponds to the signature, the identifier of the virtual storage location, and the generation number, the first entry providing an identifier for the location to which the write data was written; and
providing, in a data index database, a second entry corresponding to the identifier of the virtual storage location and the generation number of the request, the second entry providing the identifier for the location to which the write data was written;
in response to determining that one or more entries in the deduplication database correspond to the signature, performing a second sub-process including:
determining whether the write data is a duplicate of any stored data that is in the backend media at one or more locations respectively provided by the one or more entries in the deduplication database that correspond to the signature;
in response to the write data not being a duplicate, performing the first sub-process; and
in response to the write data being a duplicate, performing a third sub-process that includes providing, in the data index database, a third entry corresponding to the identifier of the virtual storage location and the generation number of the request, the third entry providing an identifier for the location in the backend media of the stored data that the write data duplicates.

7. The process of claim 6, wherein the third sub-process further comprises:
(a) identifying which entry in the deduplication database corresponds to the signature and provides the identifier for the location in the backend media of the stored data that the write data duplicates; and
(b) providing in a reference database, a fourth entry that corresponds to the signature, the identifier of the virtual storage location, and the generation number of the request, the four entry providing a generation number and an identifier of a virtual storage location that corresponds to the entry identified in (a).

8. The process of claim 7, wherein the first sub-process further comprises providing in the reference database, a fifth entry that corresponds to the signature, the identifier of the virtual storage location, and the generation number of the request, the fifth entry providing the identifier of the virtual storage location and signature of the request.

9. The process of claim 6, wherein each of the second entry and the third entry further provides the signature.

10. The process of claim 6, wherein the identifier of the virtual storage location comprises a virtual volume ID and an offset.

11. The process of claim 6, wherein receiving the write request comprises:
writing the write data to a non-volatile buffer; and
reporting to a storage client that the write request is complete.

12. The process of claim 6, wherein determining the signature for the write data comprises calculating a hash of the write data.

13. The process of claim 6, wherein:
the write data has a first size; and
the backend media employs pages having a second size, the second size differing from the first size.

14. The process of claim 13, further comprising:
assigning a second generation number to a second write request that includes second write data and an identifier of a second virtual storage location, the second write data having a third size that differs from the first size and the second size; and
determining a signature of the second write data.

15. A storage system comprising:
a backend media;
a deduplication database containing a set of first entries, each of the first entries corresponding to a signature for a data pattern associated with the first entry and to a generation number and an identifier of a virtual storage location from a write that caused the data pattern to be written to the backend media, the first entry providing an identifier of a location in the backend media where the data pattern associated with the first entry is stored;
a data index database containing a set of second entries, each of the second entries corresponding to an identifier of a virtual storage location and a generation number of a write associated with the second entry, the second entry providing a location where a data pattern matching write data of the associated write is stored in the backend media and a signature of the data pattern matching the write data of the associated write;
a reference database containing a set of third entries, each of the third entries corresponding to a generation number and an identifier of a virtual storage location of a write associated with the third entry and a signature for write data of the write associated with the third entry, the third entry providing a generation number and an identifier of a virtual storage location of a write operation that caused the data pattern to be written to the backend media; and
a processing system that employs the deduplication database, the data index database, and the reference database to perform storage system operations.

16. The storage system of claim 15, further comprising non-volatile memory in which the deduplication database, the data index database, and the reference database reside.

17. The storage system of claim 15, wherein the storage system operations include a write operation that the processing system implements by:
receiving a write request;
assigning a new generation number to the write request;
determining a signature of write data of the write request;
querying the deduplication database for any of the first entries that corresponds to the signature of the write data;
in response to finding one or more of the first entries that correspond to the signature of the write data, performing a first process comprising:
comparing the write data of the write request to stored data in the backend media at one or more locations respectively provided by the one or more of the first entries;
in response to finding that the write data of the write request matches the stored data at one of the one or more locations, adding a new second entry to the data index database and a new third entry to the reference database, the new second entry providing the one of the locations;
otherwise, performing a second process comprising:
storing the write data at an unused location in the backend media;
adding a new first entry to the deduplication database;
adding a new second entry to the data index database; and
adding a new third entry to the reference database.

18. The storage system of claim 15, wherein the storage system operations include a move operation that the processing system implements by:
(a) copying a block of data from an old location in the backend media to a new location in the backend media;
(b) determining a signature of data in the block;
(c) identifying which of the first entries corresponds to the signature and provides the old location;
(d) identifying all of the third entries that correspond to the signature and provide the generation number and the identifier corresponding to the first entry identified in (c);
(e) identify all of the second entries that correspond to the generation numbers and the identifiers corresponding to the third entries identified in (d); and
(f) update the first entry identified in (c) and the second entries identified in (e) to provide the new location.

19. The storage system of claim 15, wherein the storage system operations include a garbage collection operation that the processing system implements by:
(a) identifying in the second index a plurality of the second entries that correspond to a target virtual storage location;
(b) comparing the generation numbers that correspond to the second entries identified in (a) to a range of generation numbers to identify a subset of the plurality of the second entries that are outside the range, the second entries in the subset being unneeded second entries;
(c) for each of the unneeded second entries identified in (b), identifying in the reference database one of the third entries correspond to the signature provided by the unneeded second entry and to the generation number that corresponds to the unneeded second entry; and
(d) deleting the third entries identified in (c) and the unneeded second entries identified in (b).

20. The storage system of claim 19, wherein the garbage collection operation is further implemented by:
(a) selecting a first entry in the deduplication database;
(b) identifying in the reference database any of the third entries that correspond to the signature corresponding to the first entry selected in (a);
(c) deleting the selected first entry in response to no third entry being identified in (b) or in response to determining none of the third entries identified in (b) provides the identifier of the virtual volume and the generation number corresponding to the selected first entry.
